(19) United States
(12) Patent Application Publication
(10) Pub. No.: US 2002/0126347 A1
(43) Pub. Date: Sep. 12, 2002

(54) High data rate multiple wavelength encoding

(76) Inventor: Josh N. Hogan, Los Altos, CA (US)

Correspondence Address: Josh Hogan, 620 Kingswood Way, Los Altos, CA, 94022, US

(21) Appl. No.: 09/800,816

(22) Filed: Mar. 7, 2001

(51) Int. Cl. H04J 14/02

(52) U.S. Cl. 359/124; 359/130

(57) ABSTRACT

This invention provides a means for high data multiple wavelength encoding with reduced bandwidth requirements by combining the outputs of a plurality of multiple wavelength processing modules. Each module produces a modulated optical pulse train with the pulses from each module being phase offset with respect to each other. The phase offsets are controlled by a feedback system, such that when combined, the plurality of multiple wavelength processing modules produce a high data rate sequence of substantially non-overlapping optical pulses at multiple wavelengths. The invention is compatible with highly integrated optical and electronic modules and because the wavelength processing modules are identical, additional spare modules can be included to provide redundancy.

### BACKGROUND OF THE INVENTION

This invention relates to the area of modulating optical sources to provide high data rate optical communications by means of encoding data on multiple wavelengths. This has application in such areas as the optical communications industry where Dense Wavelength Division Multiplexing (DWDM) achieves high data rate transmission by independently modulating data on to a multiplicity of optical beams, each with a different wavelength. The actual values of these wavelengths typically correspond to specific values defined by industry standards and often referred to as the ITU grid. These optical beams are typically independently modulated with data signals and then combined and propagated down a single optical fiber. Since the different wavelengths do not significantly interfere with each other the multiple wavelengths are effectively independent communications channels.

Multiple wavelength sources are typically generated by having multiple laser diodes, each designed to emit at one of the required wavelengths. Each laser diode may be fabricated so that it emits at a particular wavelength as in the case of Distributed Feed Back (DFB) lasers where the emitting wavelength is determined by the physical spacing of a distributed Bragg grating that is part of the laser diode. These individual laser diodes are independently modulated either in the electronic or optical domain. As higher modulation rates are required the preferred approach is to modulate in the optical domain. The type of modulation has heretofore typically been of the conventional “non return to zero” type. As higher modulation rates are required (such as 40 Gbit/s), the preferred approach is “return to zero” type where data is encoded by the presence or absence of a short pulse. This approach imposes increasingly higher bandwidth requirements on all aspects of the modulation process, from the electronic to the optical domain. Furthermore, this approach of using multiple laser diodes, each fabricated to emit at a different wavelength present inventory problems because of the large number of different lasers. It is also difficult to design redundancy into such systems, again because they have a large number of different laser diodes. Alternative redundancy solutions, such as tunable lasers are more expensive solutions. In any event this approach of using multiple individual lasers is not an integrated solution.

An alternative highly integrated (and therefore amenable to high volume, low cost fabrication) approach to generating multiple wavelengths for modulation than that of having multiple laser diodes, each radiating at different wavelengths has been described in two U.S. patent applications Express Mail Label No. EF246731316 US, Filing Date Dec. 8, 2000, Internal No. JH20003 & Express Mail Label No. EF246731418 US, Filing Date Dec. 8, 2000, Internal No. JH20004. The disclosure of these U.S. patent applications is hereby incorporated herein by reference. The approach described in these applications involves such techniques as propagating radiation from a single high peak power gain switched laser diode through a non-linear medium to generate a set of wavelengths. The approach uses a combination of reflective fiber Bragg gratings designed to reflect at the desired wavelength values, a harmonically related optical pulse repetition rate and a resonant cavity in which the round trip time is also harmonically related to the pulse repetition rate and the frequency separation of the wavelength set. This approach enables generating repetitive pulsed radiation at a multiplicity of wavelengths and while it is a highly integrated approach, in order to achieve the high repetition rates suitable for the high data rate requirements involves technically difficult high bandwidth, high peak current issues. Furthermore, with this approach the energy per wavelength is also limited by high bandwidth, high peak current switching issues. Therefore there is an unmet need for a high data rate, multiple wavelength, integrated encoding method and apparatus that has built in redundancy and does not require high bandwidth modulation or high bandwidth, high peak current switching,.

### SUMMARY OF THE INVENTION

This invention provides a means for high data rate multiple wavelength encoding with reduced bandwidth requirements by means of first generating a plurality of sets of lower frequency pulsed multiple wavelengths, modulating each set and then combining the modulated wavelengths into a single fiber. The ratio of the pulse width to the repetition period is related to the number of the plurality of sets. The phase alignment of pulses from each set is such that when combined, the pulses form an evenly spaced, substantially non-overlapping pulse train that constitutes a data rate that is higher than the individual modulating rate of each set, but with a bandwidth compatible with the lower repetition rate of each set. The system can also have built in redundancy.

### BRIEF DESCRIPTION OF THE DRAWINGS

FIG. 1 is an illustration of the preferred embodiment of the invention taught herein.

FIG. 2 is a more detailed illustration of the wavelength processing module.

FIG. 3 is an illustration of a wavelength separator, modulator and combining module.

FIG. 4 is an illustration of a typical optical and electronic pulse waveforms.

FIG. 5 is an illustration of a wavelength processing module with reflective modulators.

FIG. 6 is an illustration of a configuration with a redundant multiple wavelength generator.

### DETAILED DESCRIPTION OF THE INVENTION

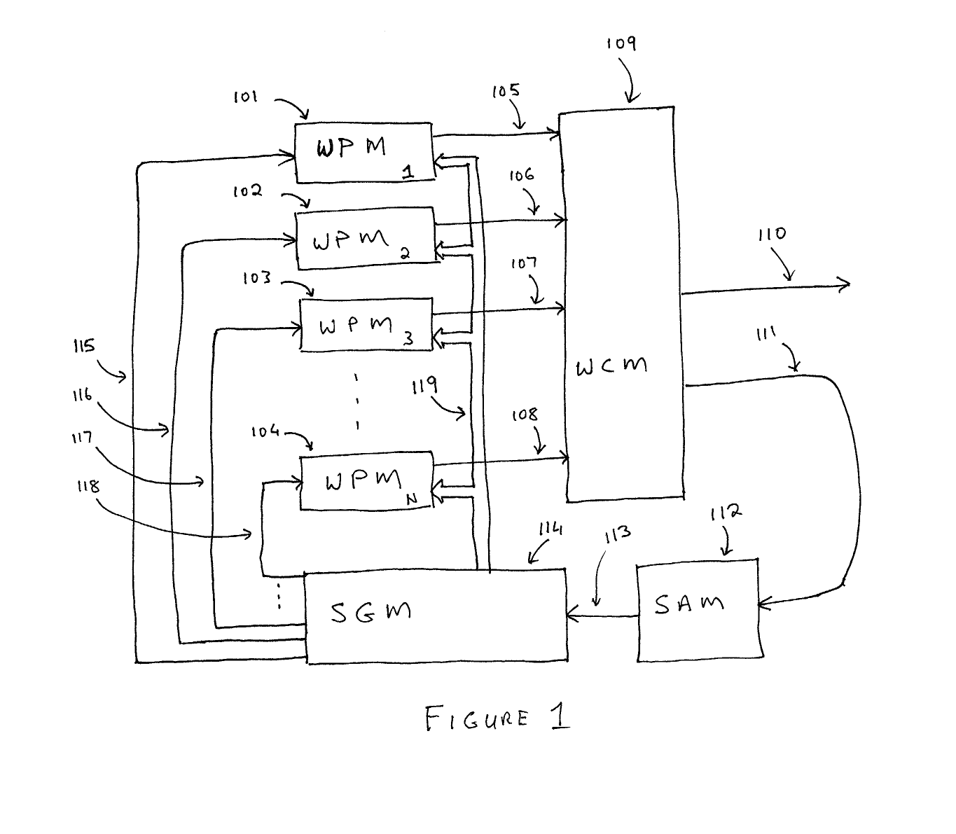

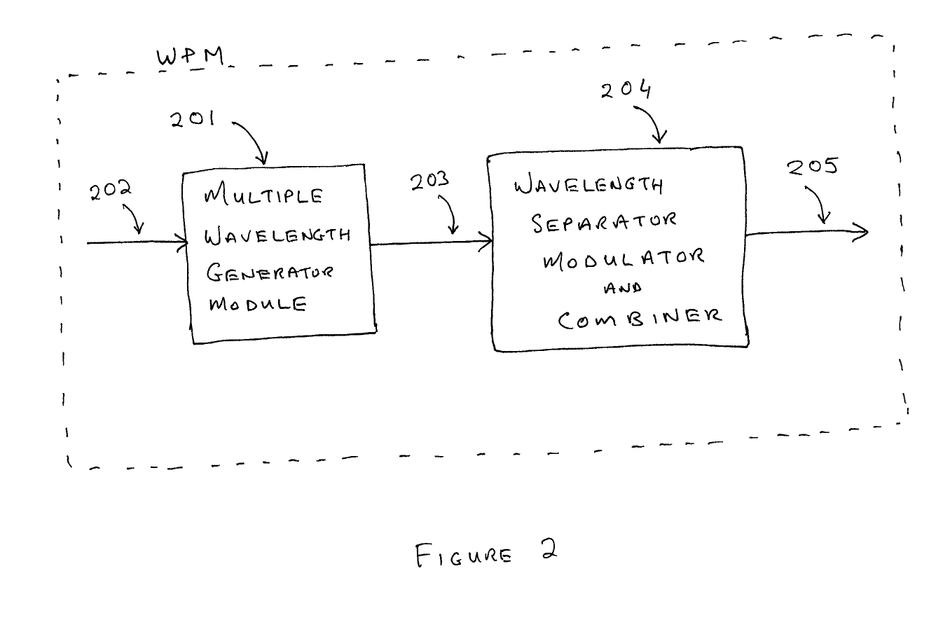

A preferred embodiment of the invention for high data rate multiple wavelength encoding is illustrated in and described with reference to FIG. 1. A plurality (N) of Wavelength Processing Modules (WPM) 101, 102, 103 to 104 , which are described in more detail in FIG. 2, each produce a set of repetitive modulated optical pulses at a multiplicity of discrete wavelengths, which are each output on a single fiber connection 105, 106, 107 to 108. The plurality of fibers are combined in a Wavelength Combining Module (WCM) 109, such as a fiber coupling device. The Wavelength Combining Module 109 outputs the combined optical pulses as a high data rate modulated pulses train at a multiplicity of wavelengths on the output fiber 110. A sample of the optical pulses are also routed by means of an other fiber 111, to a Signal Analyzing Module (SAM) 112, where the sample of the optical pulses is analyzed to produce relative phase information of the pulses from the plurality of Wavelength Processing Modules. This phase information 113 is sent to the Sync Generator Module (SGM) 114. The Sync Generator Module 114 provides reference signals 115, 116, 117 to 118 which determine the relative phase of the optical pulses from each of the plurality of Wavelength Processing Modules. The Sync Generator Module 114 also sends control information to each of the Wavelength Processing Module, by means of the signal bus 119 to control the generation of the pulses that are used by the Signal Analyzing Module 112 to measure relative phase information.

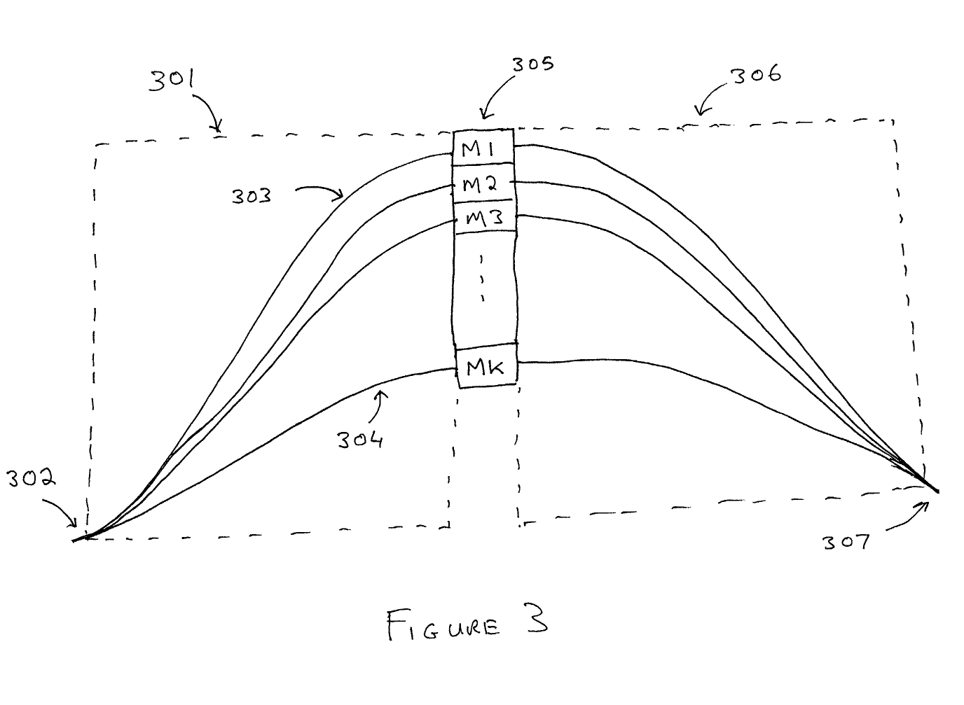

The Wavelength Processing Module (WPM) is described in more detail in FIG. 2. It consists of a Multiple Wavelength Generating Module which generates a set of repetitive pulsed radiation, or repetitive optical pulses, at a multiplicity of wavelengths. The phase of the repetitive optical pulses is determined by the reference signal 202. The output of this module is routed, by means of a fiber 203 to a module 204, described in more detail in FIG. 3, that separates the wavelengths, modulates individual wavelengths, re-combines the wavelengths and outputs the modulated optical pulses at a multiplicity of wavelengths on a single fiber 205.

The Wavelength Separator Modulator and Combiner (WSMC) module 204 is illustrated in more detail in FIG. 3, where a wavelength separator 301, such as an arrayed waveguide grating, separates the wavelengths that arrive in a combined manner at the input 302 into “k” spatially separated individual wavelengths 303 to 304. These individual wavelengths are routed through a set of k modulators 305 also labeled Ml to Mk. The modulated output pulses of this set of modulators are then re-combined in a wavelength combiner 306, such as an arrayed wave guide grating and made available at the output of the module 307.

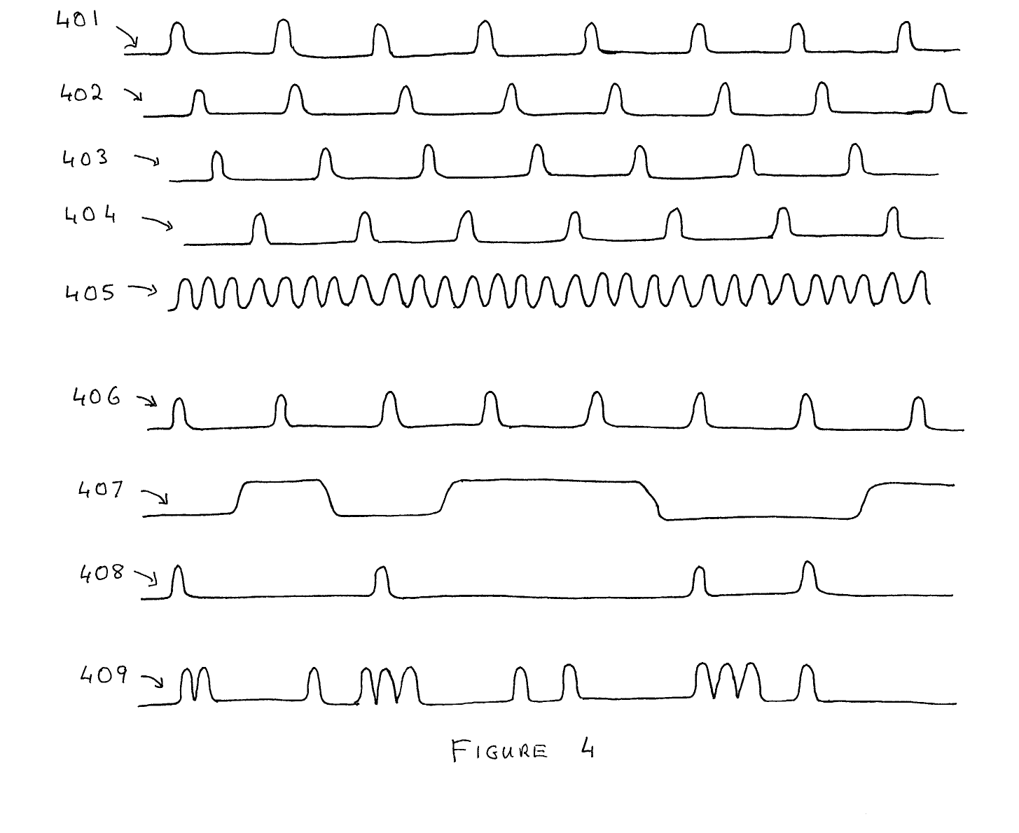

In FIG. 1 a plurality (N) of Wavelength Processing Modules 101, 102, 103 to 104, are depicted. For descriptive purposes only, a value of N=4 which would indicate a plurality of 4 will be used in this description of the preferred embodiment. The outputs of the modules 101, 102, 103 and 104, which are on the single fibers 105, 106, 107 and 108 are combined in the Wavelength Combiner Module 109. The output 110 of this module consists of multiple wavelengths encoded at a high data rate. A small sample of this output is separated from the main output, for example by a fiber coupler, and is routed by means of another fiber 111 to a Signal Analyzer Module 112. The output of this signal analyzer module 113 is made available to a Sync Generator Module 114. This Sync Generator Module generates reference signals 115, 116, 117 and 118 which control the repetition rate and phase of the pulsed radiation of each of the multiple wavelength generators 101, 102, 103 and 104. The Sync Generator module 114 can also override and control at least some of the modulators in each of the Wavelength Processing Modules 101, 102, 103 and 104. By this means the Sync Generator Module 118 can isolate and control the phase of the pulses from the individual Wavelength Processing Modules. For example, the multiple wavelength generators 201 could generate a small number of wavelengths in addition to those that are required to be output and these wavelengths could be modulated (at a relatively low frequency) for phase alignment purposes. These wavelengths would then be the sample separated and output on 111 to be made available to the Signal Analyzer Module 112. For example, the additional wavelengths could be selected from the main fiber by means of fibers coupled to the main fiber, with Bragg gratings that only allowed specific wavelengths to be coupled out. The ideal relative phase of the pulses from the different generators (at 112) consists of evenly spaced, substantially non-overlapping pulses. These pulse trains and typical examples of the modulated and combined versions are illustrated in FIG. 4. The pulse trains 401, 402, 403 and 404 show the 90 degree relative phase offset between the pulses from the four multiple wavelength generators. Pulse train 405 shows un-modulated versions of these four pulse trains after they have been combined to form an evenly spaced higher frequency pulse train. The signal 406 illustrates an un-modulated pulse train (such as 401) and 407 a typical modulating signal that would be applied to one modulator of the set of modulators 305. The modulated output train is represented by 408. In this example of the preferred embodiment, four signals at each of the k wavelengths, similar to 408, but with the 90 degree phase offset would be combined in the wavelength combiner module 109 to produce a high frequency modulated pulse train, of which 409 is a typical example.

At start up of the system, the Sync Generator 114 selectively and sequentially enables the individual pulse trains 401, 402, 403 and 404 of at least some of the wavelengths by means of the control data bus system 119 of FIG. 1. The signal analyzer module 112 detects the optical signals coupled from the Wavelength Combiner Module 109 and then the Sync Generator Module 114, uses this information to phase align the pulse trains 401, 402, 403 and 404 by means of adjusting the phases of the reference signals 115, 116, 117 and 118. After start up, the phase alignment is maintained by continuously monitoring the phase of the pulse trains of the additional wavelengths by means of the Signal Analyzer Module 112.

The modulating signal 407 clearly has a repetition rate that does not exceed the repetition of the signals 401, 402, 403 and 404. Furthermore, the alignment between the modulating signal 407 and the un-modulated pulse train 406 is not critical. By this means, a high frequency modulated pulse train, such as illustrated in 409, is generated using relatively low frequency modulators without critical alignment. Furthermore, the average power of the final high frequency pulse train, such as 409, is increased by the number of independent pulse trains that are combined (which in this example is four), thus providing a means for generating a high power, high data rate, modulated pulse train without high bandwidth requirements.

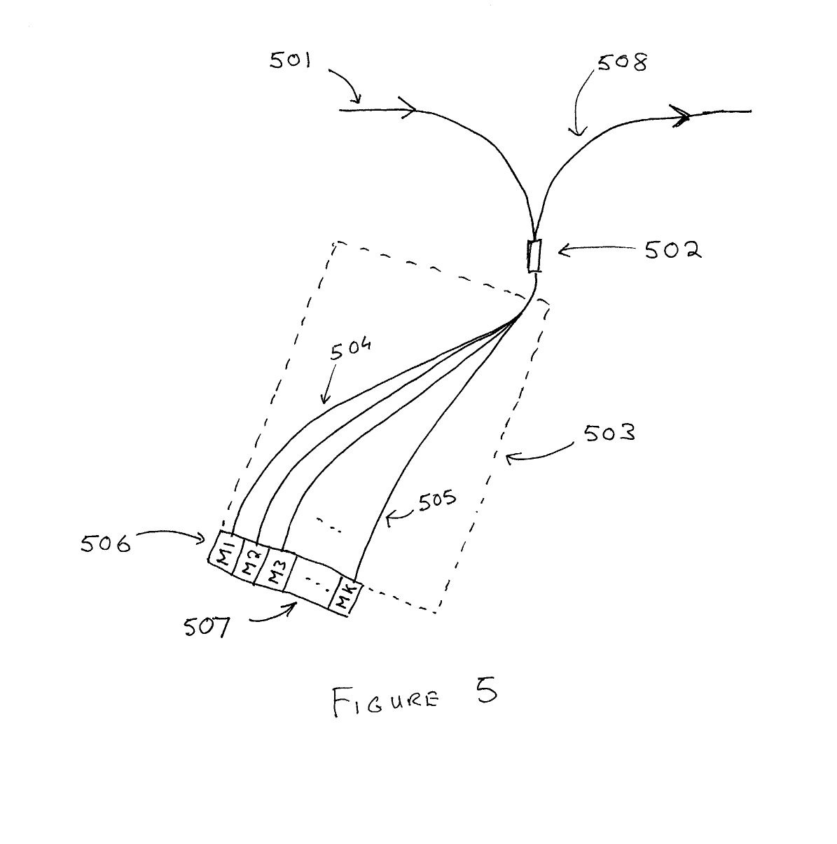

In an second preferred embodiment, the wavelength separator modulator and combiner modules, 204 in FIG. 2, consist of a single device that serves both as a wavelength separator and wavelength combiner. This is illustrated in FIG. 5, where the combined multiple wavelength is input by means of the input fiber 501 through an optical circulator 502 to a wavelength separator 503, such as an arrayed waveguide grating, which separates the optical signal into k individual wavelengths 504 to 505. These k wavelengths are applied to a set of k reflective modulators 506 (such as electro-absorption modulators) by which the pulsed radiation is modulated in a similar manner to that described above. One side 507 of the modulator set is highly reflective and reflects the radiation back through the modulator set, thus doubling the interaction length of the modulators, to be recombined by the same device 503 that separated the wavelengths and then to emerge through the optical circulator 502. This circulator 502 routes the output signal through a second port 508, to form the output of the module. A key advantage (in addition to longer interaction length and lower part count) of this reflective approach is that it enables very simple interconnection between the electronic signals driving the modulators, in that with this reflective configuration a set of electronic drivers can mate directly to the set of reflective modulators, with all drivers and modulators having exactly the same configuration, thus facilitating integration. Other aspects of this second preferred embodiment are similar to the first preferred embodiment.

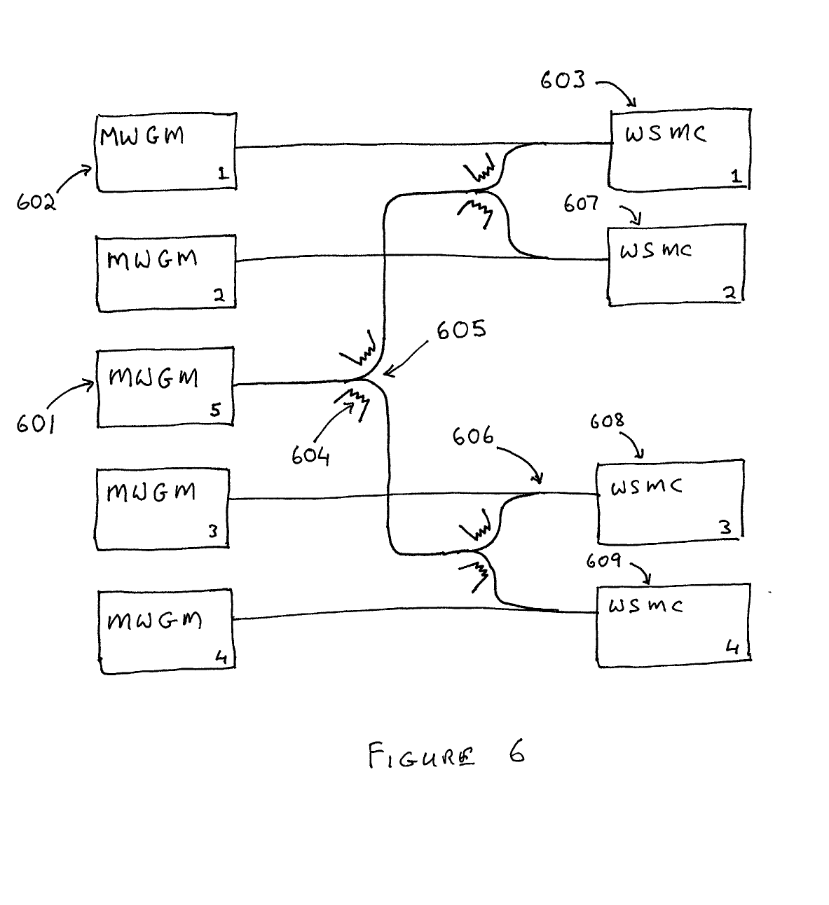

In a third preferred embodiment, the number of Wavelength Processing Modules (101, 102, 103 to 104 of FIG. 1) exceeds the number required to generate the required number of sets of multiple wavelength repetitive optical pulse trains. These Wavelength Processing Modules are all identical and therefore interchangeable, which means pulses from any one can Wavelength Processing Module can occupy the time slot of any other. Having more Wavelength Processing Modules than required and the fact that they are all identical, enables a redundant system, in which one or more spare Wavelength Processing Modules are available. For example, the system described in the first preferred embodiment could have five Wavelength Processing Modules, rather than four (as in the example). This would allow the Signal Analyzer Module 112 and the Sync Generator Module 114 in FIG. 1 to detect if one of the initial four Wavelength Processing Modules becomes defective, to disable it and then to enable the fifth (spare or redundant) Wavelength Processing Module phase aligned with (or occupying the same time slot of) the defective module. This enabled spare wavelength processing module is modulated with the same data channel with which the defective module had been modulated. Alternately, the Sync Generator Module 114 could continuously rotate the five Wavelength Processing Modules and in the event of one of them becoming defective, revert to only using the remaining four that are not defective. By such means, a high data rate multiple wavelength modulated pulse train can be generated by a system with built in redundancy. Another alternative redundant implementation, illustrated in FIG. 6, is to only have spare (or redundant) multiple wavelength generator modules (MWGM) 602 and no spare wavelength separator modulator and combiner modules (WSMC) 603. The spare multiple wavelength generator module 601 can replace a defective generator by such means as a combination of thermo-optic switches that allow the output of the spare multiple wavelength generator to be routed so that it can replace a defective multiple wavelength generator. A thermo-optic switch typically consists of a temperature dependant waveguide or fiber splitter that allows routing of optical radiation to one of two routes by means of controlling heaters such as 604 in FIG. 6. The combination of heaters 604, splitters 605 and combiners 606 allow the multiple wavelength output of the spare multiple wavelength generator module 601 to be routed to any of the wavelength separator modulator and combiner modules 603, 607, 608 or 609. The output of the corresponding defective multiple wavelength generator, that is being replaced, would be disabled and ideally its defective status used to indicate that it should be replaced.

It is understood that the above description is intended to be illustrative and not restrictive. Many of the features have functional equivalents that are intended to be included in the invention as being taught. For example, wavelength separators other than arrayed waveguide gratings, such as optical filters, could be used, or instead of modulator sets, fiber optical modulators could be used. Various other combinations of fiber elements, waveguide elements, modulator elements and wavelength combiner elements can be employed. Other examples will be apparent to persons skilled in the art.

The scope of this invention should therefore not be determined with reference to the above description, but instead should be determined with reference to the appended claims, along with the fill scope of equivalents to which such claims are entitled.

What is claimed is:

1. A method of encoding multiple wavelengths at a high data rate, the method comprising:
generating a plurality of sets of repetitive pulsed radiation with a multiplicity of discrete wavelengths; and
phase offsetting pulses from different sets of repetitive pulsed radiation; and
wavelength separating at least some of the sets of repetitive pulsed radiation with a multiplicity of discrete wavelengths; and
modulating at least some of the separated wavelengths; and
combining the wavelengths, such that high data rate multiple wavelength encoding is achieved.

2. The method of claim 1, wherein the pulse width of the pulsed radiation is related to the period of the repetition rate and to the number of sets of pulses being combined.

3. The method of claim 1, wherein the phase offset between pulses from different sets of pulses is related to the number of sets of pulses being combined.

4. The method of claim 1, wherein the pulse widths and phase offsets of pulses from different sets of pulses are such that, when combined, they are substantially non-overlapping.

5. The method of claim 1, wherein the phase offset between pulses from different sets of pulses are such that, when combined, they form an equally spaced higher frequency optical pulse train.

6. The method of claim 1, wherein at least some of the sets of repetitive pulsed radiation are separated into pulse trains of different wavelengths by means of arrayed waveguide gratings.

7. The method of claim 1, wherein at least some of the sets of repetitive pulsed radiation are separated into pulse trains of different wavelengths by means of coupled fibers with fiber Bragg gratings.

8. The method of claim 1, wherein at least some of the separated wavelengths are modulated by means of an array of modulators.

9. The method of claim 8, wherein the array of modulators is an array of electro-absorption modulators.

10. The method of claim 8, wherein the array of modulators is an array of reflective modulators.

11. The method of claim 10, wherein the array of reflective modulators is an array of electro-absorption modulators.

12. The method of claim 1, wherein at least some of the separated wavelengths are modulated by means of fiber modulators.

13. The method of claim 1, wherein at least some of the modulated wavelengths from the same set of repetitive pulsed radiation are combined by means of arrayed waveguide gratings.

14. The method of claim 1, wherein at least some of the modulated wavelengths are combined by means of coupled optical fibers.

15. The method of claim 1, wherein the same device that separates the wavelengths is used to re-combine the modulated wavelengths.

16. The method of claim 1, wherein at least some of the wavelengths are modulated to encode digital data.

17. The method of claim 1, wherein at least some of the wavelengths are modulated with a repetitive digital signal.

18. The method of claim 1, wherein pulses from different sets of repetitive pulsed radiation are phase offset in response to the phases of at least some of the modulated wavelengths.

19. The method of claim 18, wherein phase offsetting is accomplished by means that include converting some of the pulses radiation to electronic signals.

20. The method of claim 18, wherein phase offsetting is accomplished by means that include controlling reference signals for the generators of the sets of repetitive pulsed radiation.

21. A method of encoding multiple wavelengths at a high data rate, the method comprising:
generating a plurality of sets of modulated pulsed radiation with a multiplicity of discrete wavelengths by means of a plurality of wavelength processing modules; and
phase offsetting pulses from at least some of the wavelength processing modules; and
disabling the signals at the outputs of at least some of the wavelength processing modules; and
combining at least some of the signals at the outputs of at least some of the wavelength processing modules, such that high data rate multiple wavelength encoding is achieved in a manner that includes redundancy.

22. The method of claim 21, wherein the wavelength processing modules include, generation of repetitive pulsed radiation with a multiplicity of wavelengths, wavelength separation, wavelength modulation and wavelength combination.

23. The method of claim 21, wherein the wavelength processing modules are substantially identical.

24. The method of claim 21, wherein the plurality of sets of wavelength processing modules consists of a greater number of modules than are required to achieve the high data rate pulse train.

25. The method of claim 21, wherein the signals at the outputs of the wavelength processing modules are modulated wavelengths.

26. The method of claim 21, wherein the signals at the outputs of at least some of the wavelength processing modules are disabled.

27. The method of claim 26, wherein the signals at the outputs of at least some of the wavelength processing modules are disabled by controlling modulators.

28. The method of claim 26, wherein the signals at the outputs of at least some of the wavelength processing modules are disabled by controlling the power of laser diodes.

29. The method of claim 21, wherein the signals at the outputs of at least some of the wavelength processing modules are monitored for defective performance.

30. The method of claim 21, wherein a second wavelength processing module is phase aligned with a wavelength processing module with defective performance.

31. The method of claim 21, wherein the signals at the outputs of the wavelength processing modules with defective performance are disabled.

32. The method of claim 21, wherein the signals at the outputs of the second wavelength processing modules are enabled.

33. The method of claim 22, wherein the wavelength processing modules include, a method of selecting between the output of at least two modules that generate repetitive pulsed radiation with a multiplicity of wavelengths.

34. The method of claim 33, wherein the modules being selected between are phase aligned.

35. The method of claim 21, wherein at least some wavelength processing modules include optical switching elements.

36. An apparatus for encoding multiple wavelengths at a high data rate, the apparatus consisting of:
an optically active element operable to generate a plurality of sets of repetitive pulsed radiation with a multiplicity of discrete wavelengths; and
phase alignment elements operable to phase offset pulses from different sets of repetitive pulsed radiation; and
wavelength separating elements operable to wavelength separate at least some of the sets of repetitive pulsed radiation with a multiplicity of discrete wavelengths; and
modulating elements operable to modulate at least some of the separated wavelengths; and
wavelength combining elements operable to combine the wavelengths, such that high data rate multiple wavelength encoding is achieved.

37. The apparatus of claim 36, wherein the pulse width of the pulsed radiation is related to the period of the repetition rate and to the number of sets of pulses being combined.

38. The apparatus of claim 36, wherein the phase offset between pulses from different sets of pulses is related to the number of sets of pulses being combined.

39. The apparatus of claim 36, wherein the pulse widths and phase offsets of pulses from different sets of pulses are such that, when combined, they are substantially non-overlapping.

40. The apparatus of claim 36, wherein the phase offset between pulses from different sets of pulses are such that, when combined, they form an equally spaced higher frequency optical pulse train.

41. The apparatus of claim 36, wherein at least some of the sets of repetitive pulsed radiation are separated into pulse trains of different wavelengths by means of arrayed waveguide gratings.

42. The apparatus of claim 36, wherein at least some of the sets of repetitive pulsed radiation are separated into pulse trains of different wavelengths by means of coupled fibers with fiber Bragg gratings.

43. The apparatus of claim 36, wherein at least some of the separated wavelengths are modulated by means of an array of modulators.

44. The apparatus of claim 43, wherein the array of modulators is an array of electro-absorption modulators.

45. The apparatus of claim 43, wherein the array of modulators is an array of reflective modulators.

46. The apparatus of claim 45, wherein the array of reflective modulators is an array of electro-absorption modulators.

47. The apparatus of claim 36, wherein at least some of the separated wavelengths are modulated by means of fiber modulators.

48. The apparatus of claim 36, wherein at least some of the modulated wavelengths from the same set of repetitive pulsed radiation are combined by means of arrayed waveguide gratings.

49. The apparatus of claim 36, wherein at least some of the modulated wavelengths are combined by means of coupled optical fibers.

50. The apparatus of claim 36, wherein the same device that separates the wavelengths is used to re-combine the modulated wavelengths.

51. The apparatus of claim 36, wherein at least some of the wavelengths are modulated to encode digital data.

52. The apparatus of claim 36, wherein at least some of the wavelengths are modulated with a repetitive digital signal.

53. The apparatus of claim 36, wherein pulses from different sets of repetitive pulsed radiation are phase offset in response to the phases of at least some of the modulated wavelengths.

54. The apparatus of claim 53, wherein phase offsetting is accomplished by means that include converting some of the pulses radiation to electronic signals.

55. The apparatus of claim 53, wherein phase offsetting is accomplished by means that include controlling reference signals for the generators of the sets of repetitive pulsed radiation.

56. An apparatus for encoding multiple wavelengths at a high data rate, the apparatus consisting of:
an optically active element operable to generate a plurality of sets of modulated pulsed radiation with a multiplicity of discrete wavelengths by means of a plurality of wavelength processing modules; and
phase offsetting elements operable to phase offset pulses from at least some of the wavelength processing modules; and
control elements operable to disable the signals at the outputs of at least some of the wavelength processing modules; and
signal combining elements operable to combine at least some of the signals at the outputs of at least some of the wavelength processing modules, such that high data rate multiple wavelength encoding is achieved in a manner that includes redundancy.

57. The apparatus of claim 56, wherein the wavelength processing modules are operable to generate repetitive pulsed radiation with a multiplicity of wavelengths, to separate wavelengths, to modulate wavelengths and to combine wavelength.

58. The apparatus of claim 56, wherein the wavelength processing modules are substantially identical.

59. The apparatus of claim 56, wherein the plurality of sets of wavelength processing modules consists of a greater number of modules than are required to achieve the high data rate pulse train.

60. The apparatus of claim 56, wherein the signals at the outputs of the wavelength processing modules are modulated wavelengths.

61. The apparatus of claim 56, wherein the signals at the outputs of at least some of the wavelength processing modules are disabled.

62. The apparatus of claim 61, wherein the signals at the outputs of at least some of the wavelength processing modules are disabled by controlling modulators.

63. The apparatus of claim 61, wherein the signals at the outputs of at least some of the wavelength processing modules are disabled by controlling the power of laser diodes.

64. The apparatus of claim 56, wherein the signals at the outputs of at least some of the wavelength processing modules are monitored for defective performance.

65. The apparatus of claim 56, wherein a second wavelength processing module is phase aligned with a wavelength processing module with defective performance.

66. The apparatus of claim 56, wherein the signals at the outputs of the wavelength processing modules with defective performance are disabled.

67. The apparatus of claim 56, wherein the signals at the outputs of the second wavelength processing modules are enabled.

68. The apparatus of claim 57, wherein the wavelength processing modules include, an apparatus for selecting between the output of at least two modules that generate repetitive pulsed radiation with a multiplicity of wavelengths.

69. The apparatus of claim 68, wherein the modules being selected between are phase aligned.

70. The apparatus of claim 56, wherein at least some wavelength processing modules include optical switching elements.

71. A means of encoding multiple wavelengths at a high data rate, the means comprising:
means for generating a plurality of sets of repetitive pulsed radiation with a multiplicity of discrete wavelengths; and
means for phase offsetting pulses from different sets of repetitive pulsed radiation; and
means for wavelength separating at least some of the sets of repetitive pulsed radiation with a multiplicity of discrete wavelengths; and
means for modulating at least some of the separated wavelengths; and
means for combining the wavelengths, such that high data rate multiple wavelength encoding is achieved.

72. A means of encoding multiple wavelengths at a high data rate, the means comprising:
means for generating a plurality of sets of modulated pulsed radiation with a multiplicity of discrete wavelengths by means of a plurality of wavelength processing modules; and
means for phase offsetting pulses from at least some of the wavelength processing modules; and
means for disabling the signals at the outputs of at least some of the wavelength processing modules; and
means for combining at least some of the signals at the outputs of at least some of the wavelength processing modules, such that high data rate multiple wavelength encoding is achieved in a manner that includes redundancy.
